(19) United States
(12) Patent Application Publication
(10) Pub. No.: US 2026/0302047 A1
(43) Pub. Date: Oct. 1, 2026

(54) MAGNETICALLY-COUPLING COIL COMPONENT

(71) Applicant: TAIYO YUDEN CO., LTD., Tokyo (JP)

(72) Inventors: Shinya AKIYAMA, Tokyo (JP); Tomoyuki OYOSHI, Tokyo (JP)

(21) Appl. No.: 19/553,902

(22) Filed: Mar. 2, 2026

(30) Foreign Application Priority Data
Mar. 28, 2025 (JP) 2025-057125

(51) Int. Cl. H01F 27/28

(52) U.S. Cl. CPC H01F 27/2852

(57) ABSTRACT

A magnetically-coupling coil component includes: a magnetic base body including: an intermediate magnetic layer; and a first magnetic layer and a second magnetic layer positioned above and below the intermediate magnetic layer, respectively; a first conductive coil positioned inside the first magnetic layer; and a second conductive coil positioned inside the second magnetic layer. The first conductive coil includes: a first conductive pattern; and a second conductive pattern electrically connected in series to the first conductive pattern and positioned farther from the intermediate magnetic layer than is the first conductive pattern. The second conductive coil includes: a third conductive pattern; and a fourth conductive pattern electrically connected in series to the third conductive pattern and positioned farther from the intermediate magnetic layer than is the third conductive pattern. The first conductive pattern and the third conductive pattern are thinner than the second conductive pattern and the fourth conductive pattern, respectively.

### CROSS-REFERENCE TO RELATED APPLICATIONS

This patent application is based on and claims priority to Japanese Patent Application No. 2025-057125, filed on Mar. 28, 2025, the entire contents of which are incorporated herein by reference.

### TECHNICAL FIELD

The present disclosure relates to a magnetically-coupling coil component.

### BACKGROUND

A magnetically-coupling coil component includes a pair of coil conductors that are coupled with each other magnetically. Magnetically-coupling coil components include choke coils, transformers, and coupled inductors.

### RELATED ART DOCUMENTS

### Patent Documents

Patent Document 1: Unexamined Japanese Patent Application Publication No. 2016-131208
Patent Document 2: Unexamined Japanese Patent Application Publication No. 2005-064321
Patent Document 3: Unexamined Japanese Patent Application Publication No. 2020-013936
Patent Document 4: Unexamined Japanese Patent Application Publication No. 2020-013937

### SUMMARY

According to an example of the present disclosure, a magnetically-coupling coil component is provided. This magnetically-coupling coil component includes: a magnetic base body including: an intermediate magnetic layer; a first magnetic layer positioned above the intermediate magnetic layer; and a second magnetic layer positioned below the intermediate magnetic layer; a first conductive coil positioned inside the first magnetic layer; and a second conductive coil positioned inside the second magnetic layer. The first conductive coil includes: a first conductive pattern; and a second conductive pattern electrically connected in series to the first conductive pattern and positioned farther from the intermediate magnetic layer than is the first conductive pattern. The second conductive coil includes: a third conductive pattern; and a fourth conductive pattern electrically connected in series to the third conductive pattern and positioned farther from the intermediate magnetic layer than is the third conductive pattern. The first conductive pattern is thinner than the second conductive pattern. The third conductive pattern is thinner than the fourth conductive pattern.

### BRIEF DESCRIPTION OF THE DRAWINGS

FIG. 1 is a perspective view showing a magnetically-coupling coil component according to a first embodiment;

FIG. 2 is an exploded perspective view showing the magnetically-coupling coil component according to the first embodiment;

FIG. 3 is a cross-sectional view showing the magnetically-coupling coil component according to the first embodiment;

FIG. 4A is a plan view showing a magnetic film with a conductive pattern formed thereon;

FIG. 4B is another plan view showing a magnetic film with a conductive pattern formed thereon;

FIG. 4C is another plan view showing a magnetic film with no conductive pattern formed thereon;

FIG. 4D is another plan view showing a magnetic film with a conductive pattern formed thereon;

FIG. 4E is another plan view showing a magnetic film with a conductive pattern formed thereon;

FIG. 4F is another plan view showing a magnetic film with no conductive pattern formed thereon;

FIG. 4G is another plan view showing a magnetic film with no conductive pattern formed thereon;

FIG. 5 is a cross-sectional view showing a magnetically-coupling coil component according to a second embodiment;

FIG. 6 is a cross-sectional view showing a magnetically-coupling coil component according to a third embodiment;

FIG. 7A is a diagram showing a first simulation's result;

FIG. 7B another diagram showing the first simulation's result;

FIG. 8 is a diagram showing a second simulation's result;

FIG. 9 is a diagram showing a third simulation's result; and

FIG. 10 is a diagram showing a fourth simulation's result.

### DETAILED DESCRIPTION

Magnetically-coupling choke coils are widely used in chopper-type DC-DC converters. When the output current of a DC-DC converter is changed by turning on or off a load connected thereto, the output voltage undergoes a momentary significant increase or a decrease and then resumes its stationary state. If this upward or downward change of voltage during the transient state is too large, for example, circuits connected to the DC-DC converter may be damaged or malfunction. Furthermore, if a significant change in voltage occurs during the transient state, it takes a longer time before the DC-DC converter's output voltage resumes its stationary state. In chopper-type DC-DC converters, increasing the choke coil's coupling factor can reduce the change of output voltage.

In a magnetically-coupling coil component, generally, it is desirable if a pair of coil conductors are coupled strongly. Proposals for increasing the coupling factor of a magnetically-coupling coil component have been made in the past. For example, Patent Document 1 discloses a magnetically-coupling coil component, in which a pair of coil conductors are embedded inside a magnetic base body such that the coil conductors come in close contact with each other and their winding axes are aligned substantially. Furthermore, Patent Document 2 discloses a magnetically-coupling coil component, in which a pair of coil conductors are embedded inside a magnetic base body, and in which a spacer having lower permeability than the magnetic base body is provided between the pair of coil conductors.

The coupling factor indicates how strongly a pair of coil conductors are coupled together and is determined by: the self-inductance L₁ of one coil conductor; the self-inductance L₂ of the other coil conductor; and the mutual inductance M between the two coil conductors, as shown in the following mathematical expression 1. In the mathematical expression 1: k is the coupling factor; L₁ is the self-inductance of one coil conductor; L₂ is the self-inductance of the other coil conductor; and M is the mutual inductance.

### [Mathematical Expression 1]

$$k = \frac{M}{\sqrt{{L}_{1} {L}_{2}}}$$

Using thin coil conductors and increasing their winding density may be one way of improving the coupling factor. However, when the coil conductors are thinner, the coil conductors' electrical resistance increases. Increased electrical resistance leads to energy loss. A large DC current may flow through a magnetically-coupling coil component. For example, a large current is expected to flow through the choke coil used in a DC-DC converter. The larger the current, the more significant the energy loss due to the coil conductors' electrical resistance.

The present disclosure therefore aims to provide a magnetically-coupling coil component that can improve the coupling factor while preventing or substantially preventing an increase in electrical resistance.

The present disclosure makes it possible to improve the coupling factor while preventing or substantially preventing an increase in electrical resistance.

Embodiments of the present disclosure will be described below, but the present disclosure is by no means limited to the following embodiments. Throughout the specification and the accompanying drawings, components with the same or substantially the same functions will be assigned the same reference numerals, so that their explanation will not be repeated. Note that the accompanying drawings are not necessarily drawn to scale for ease of explanation.

### First Embodiment

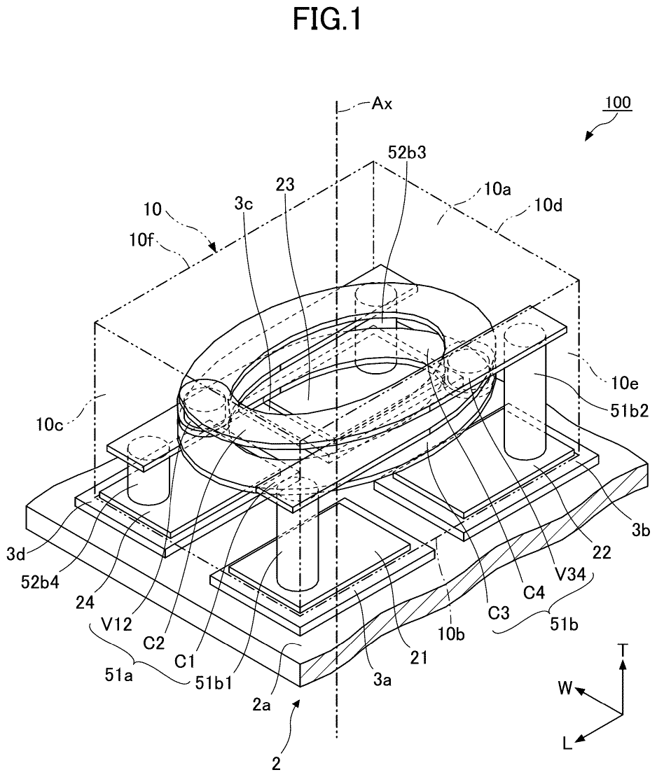

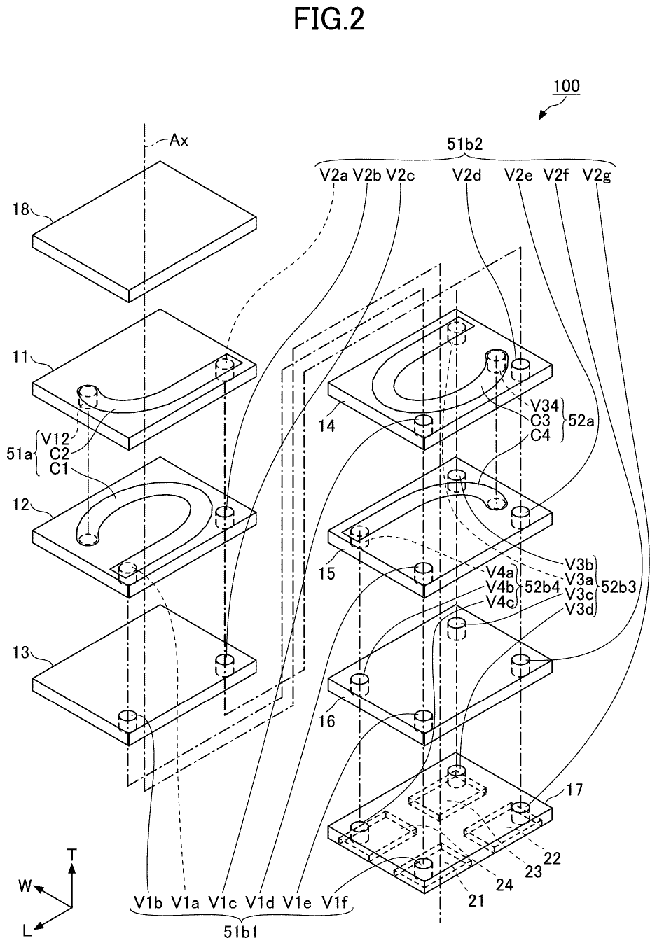

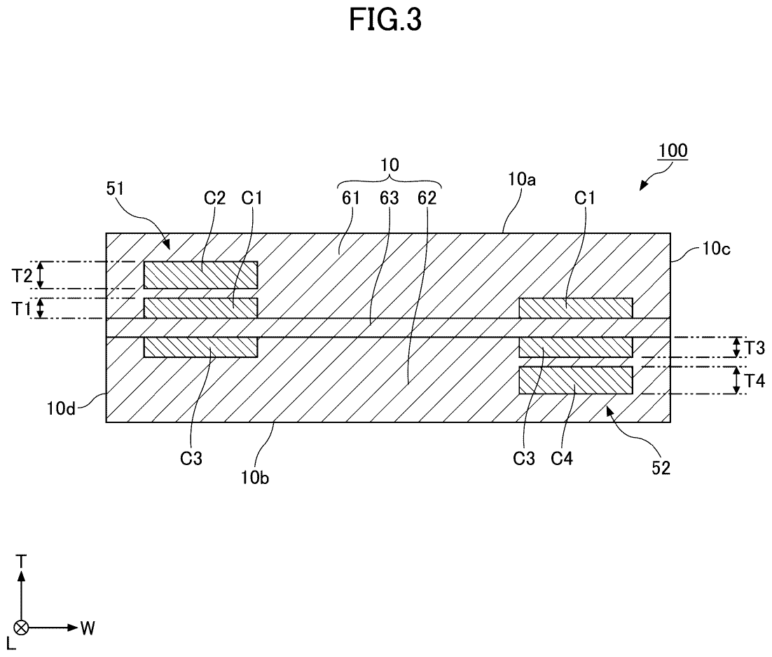

A first embodiment will be described. The first embodiment relates to a magnetically-coupling coil component with a pair of coil conductors. FIG. 1 is a perspective view showing the magnetically-coupling coil component according to the first embodiment. FIG. 2 is an exploded perspective view showing the magnetically-coupling coil component according to the first embodiment. FIG. 3 is a cross-sectional view showing the magnetically-coupling coil component according to the first embodiment. For ease of view, no outer terminals are shown in FIG. 2 and FIG. 3.

As shown in FIG. 1 to FIG. 3, the magnetically-coupling coil component 100 according to the first embodiment includes: a magnetic base body 10; a first conductive coil 51; a second conductive coil 52; a first outer terminal 21; a second outer terminal 22; a third outer terminal 23; and a fourth outer terminal 24. Hereinafter, the “magnetically-coupling coil component” may be simply referred to as a “coil component,” and the “magnetic base body” may be simply referred to as a “base body.” The magnetic base body 10 includes: an intermediate magnetic layer 63; a first magnetic layer 61 positioned longitudinally above the intermediate magnetic layer 63; and a second magnetic layer 62 positioned longitudinally below the intermediate magnetic layer 63. The first conductive coil 51 is positioned inside the first magnetic layer 61. The second conductive coil 52 is positioned inside the second magnetic layer 62. In the base body 10, the first conductive coil 51 and the second conductive coil 52 are electrically insulated from each other.

In this specification, unless otherwise understood from the context, the “length” direction, the “width” direction, and the “thickness” direction of the coil component 100 correspond to the “L” direction, the “W” direction, and the “T” direction in FIG. 1 to FIG. 3, respectively.

The coil component 100 can be mounted on a mounting substrate 2a. The mounting substrate 2a is provided with land parts 3a, 3b, 3c, and 3d. The coil component 100 is mounted on the mounting substrate 2a by: joining the first outer terminal 21 and the land part 3a together; joining the second outer terminal 22 and the land part 3b together; joining the third outer terminal 23 and the land part 3c together; and joining the fourth outer terminal 24 and the land part 3d together. A circuit substrate 2 includes: the coil component 100; and the mounting substrate 2a on which the coil component 100 is mounted. The circuit substrate 2 can be installed in a variety of electronic devices. Electronic devices in which the circuit substrate 2 may be installed include smartphones, tablet devices, game consoles, automotive electrical components, servers, and various other electronic devices.

The coil component 100 may be an inductor, a transformer, a filter, a reactor, an inductor array, or any other type of coil component. The coil component 100 may be a coupled inductor, a choke coil, or any other type of magnetically-coupling coil component. The use of the coil component 100 is not limited to what is described in this specification.

When referring to the top and bottom in the structure of the coil component 100 or its constituent parts in this specification, unless otherwise interpreted, assuming that the coil component 100 is mounted on top of the mounting substrate 2a, the direction to get closer to the mounting substrate 2a will be referred to as or associated with expressions such as “down,” “downward,” “lower,” “below,” “bottom,” and so forth, whereas the direction to get further away from the mounting substrate 2a will be referred to as or associated with expressions such as “up,” “upward,” “higher,” “above,” “top,” and so forth. In the event the upward and downward directions are expressed using the coordinate axes shown in FIG. 1, the positive direction on the T-axis is defined as toward the “top” of the coil component 100, and the negative direction on the T-axis is defined as toward the “bottom” of the coil component 100. These upward and downward directions may not coincide with the vertical direction, depending on the orientation/angle of the mounting substrate 2a.

The base body 10 is formed in a rectangular parallelepiped shape. The lengthwise dimension of the coil component 100 may be greater than its widthwise dimension. When this specification refers to a “rectangular parallelepiped” or a “rectangular parallelepiped shape,” it does not necessarily mean a “rectangular parallelepiped” in the strict mathematical sense.

The magnetic base body 10 has a first main surface 10a, a second main surface 10b, a first end surface 10c, a second end surface 10d, a first side surface 10e, and a second side surface 10f. The first end surface 10c, the second end surface 10d, the first side surface 10e, and the second side surface 10f are connected to the second main surface 10b. The first end surface 10c also connects the first side surface 10e and the second side surface 10f. The second end surface 10d also connects the first side surface 10e and the second side surface 10f. The corners and sides of the base body 10 may be curved. In the event the sides of the base body 10 are curved, then, among the first main surface 10a, the second main surface 10b, the first end surface 10c, the second end surface 10d, the first side surface 10e, and the second side surface 10f, surfaces that are located next to each other are connected with each other via curved surfaces. In this way, the first end surface 10c, the second end surface 10d, the first side surface 10e, and the second side surface 10f are directly connected to the second main surface 10b or indirectly connected to the second main surface 10b via curved surfaces. In the event the sides of the base body 10 are curved, the outer surface of the base body 10 is composed of: the first main surface 10a; the second main surface 10b; the first end surface 10c; the second end surface 10d; the first side surface 10e; the second side surface 10f; and the curved surfaces where surfaces that are located next to each other among these surfaces are connected.

The first main surface 10a and the second main surface 10b provide surfaces at both heightwise ends of the base body 10. The first end surface 10c and the second end surface 10d provide surfaces at both lengthwise ends of the base body 10. The first side surface 10e and the second side surface 10f form provide surfaces at both widthwise ends of the base body 10. As shown in FIG. 1, the first main surface 10a is located in an upper part of the base body 10 and may therefore be referred to as the “upper” or “top” surface of the base body 10. Similarly, the second main surface 10b may be referred to as the “lower” or “bottom” surface. The second main surface 10b of the coil component 100 is positioned to face the mounting substrate 2a, so the second main surface 10b may be referred to as the “mounting surface.” The first main surface 10a and the second main surface 10b are separated by the heightwise dimension of the base body 10. The first end surface 10c and the second end surface 10d are separated by the lengthwise dimension of the base body 10. The first side surface 10e and the second side surface 10f are separated by the widthwise dimension of the base body 10.

The base body 10 is made from a magnetic material. The magnetic material for the base body 10 can be: a soft magnetic alloy material; a composite magnetic material in which magnetic particles are dispersed in resin; a ferrite material; or any other existing magnetic material.

The soft magnetic metal particles contained in the magnetic material for the base body 10 may include at least one element among Fe, Ni, and Co as a primary component, and include at least one element among Si, Cr, Al, B, and P as an additive. The soft magnetic metal particles contained in the magnetic material for the base body 10 may be, for example: crystalline alloy particles such as Fe—Si—Cr alloy, Fe—Si—Al alloy, or Fe—Ni alloy particles; amorphous alloy particles such as Fe—Si—Cr—B—C alloy or Fe—Si—Cr—B alloy particles; or mixed particles combining these alloys. The composition of the soft magnetic metal particles constituting the base body 10 is not limited to the above examples. For example, the soft magnetic metal particles constituting the base body 10 may be a Co—Nb—Zr alloy, an Fe—Zr—Cu—B alloy, an Fe—Si—B alloy, an Fe—Co—Zr—Cu—B alloy, an Ni—Si—B alloy, or an Fe—Al—Cr alloy.

An insulating film may be formed over the surface of each soft magnetic metal particle constituting the base body 10. This insulating film may be an oxide film formed by oxidation of elements contained in the soft magnetic metal particles contained in the magnetic material.

The soft magnetic metal particles constituting the base body 10 have an average particle size of, for example, 1 μm to 40 μm. The base body 10 may contain two or more types of soft magnetic metal particles of varying average particle sizes. The soft magnetic metal particles constituting the base body 10 may include first soft magnetic metal particles having an average particle size of 1 μm to 40 μm, as well as second soft magnetic metal particles having a smaller average particle size than the first soft magnetic metal particles. The average particle size of the second soft magnetic metal particles is, for example, 0.1 μm to 0.5 μm. The base body 10 thus contains two types of soft magnetic metal particles having varying average particle sizes, so that the packing fraction of magnetic metal particles in the base body 10 can be improved. The volume percentage of magnetic metal particles in the total volume of the base body 10 may be 85 vol % or more, or 88 vol % or more. Increasing the packing fraction of soft magnetic metal particles in the base body 10 can improve the magnetic properties of the base body 10. Furthermore, increasing the packing fraction of soft magnetic metal particles in the base body 10 can improve the mechanical strength of the base body 10. The average particle size of soft magnetic metal particles constituting the base body 10 can be determined by cutting the base body 10 in its thickness direction (T-axis direction), exposing a cross-section, capturing its image by a scanning electron microscope (SEM), and determining the distribution of volumetric particle size from the SEM image. For example, in the event the average particle size calculated from the volumetric particle size distribution determined from the SEM image can be used as the average particle size (median diameter (D50)) of the soft magnetic metal particles constituting the base body 10. The particle size of the first soft magnetic metal particles may vary within a range of 1 μm to 60 μm. The particle size of the second soft magnetic metal particles may vary within a range of 0.01 μm to 1 μm.

The soft magnetic metal particles constituting the base body 10 may be coupled together by means of an oxide film, which may be formed by oxidation of elements contained in the soft magnetic metal particles during the manufacturing process. In addition to these soft magnetic metal particles, the base body 10 may also contain a binder. If the base body 10 contains a binder, the binder may allow the soft magnetic metal particles to be coupled together. The binder included in the base body 10 may be formed, for example, by curing a thermosetting resin having excellent insulating properties. As for the material of the binder, for example, an epoxy resin, a polyimide resin, a polystyrene (PS) resin, a high-density polyethylene (HDPE) resin, a polyoxymethylene (POM) resin, a polycarbonate (PC) resin, a polyvinylidene fluoride (PVDF) resin, a phenolic resin, a polytetrafluoroethylene (PTFE) resin, a polybenzoxazole (PBO) resin, etc. may be used. The binder in the base body 10 is by no means limited to those listed above. For example, the base body 10 may contain glass as a binder.

The first outer terminal 21, the second outer terminal 22, the third outer terminal 23, and the fourth outer terminal 24 are provided on the second main surface 10b of the base body 10. The first outer terminal 21, the second outer terminal 22, the third outer terminal 23, and the fourth outer terminal 24 are spaced apart from one another.

The first conductive coil 51 has a circling part 51a, a first lead part 51b1, and a second lead part 51b2. The first lead part 51b1 connects one end of the circling part 51a with the first outer terminal 21. The second lead part 51b2 connects the other end of the circling part 51a with the second outer terminal 22. The second conductive coil 52 has a circling part 52a, a third lead part 52b3, and a fourth lead part 52b4. The third lead part 52b3 connects one end of the circling part 52a with the third outer terminal 23. The fourth lead part 52b4 connects the other end of the circling part 52a with the fourth outer terminal 24.

As shown in FIG. 2, the base body 10 has magnetic films 11 to 18. The base body 10 is a laminated body, in which the magnetic films 11 to 18 are stacked on top of one another. The magnetic film 16 is positioned longitudinally above the magnetic film 17, the magnetic film 15 is positioned longitudinally above the magnetic film 16, and the magnetic film 14 is positioned longitudinally above the magnetic film 15. Likewise, the magnetic film 13 is positioned longitudinally above the magnetic film 14, the magnetic film 12 is positioned longitudinally above the magnetic 13, the magnetic film 11 is positioned longitudinally above the magnetic film 12, and the magnetic film 18 is positioned longitudinally above the magnetic film 11. However, the borders of the magnetic films 11 to 18 may not be visible when observing the cross section of the base body 10 using an SEM. Conductive patterns are formed on the upper surface of the magnetic films 11, 12, 14, and 15. A second conductive pattern C2 is formed on the upper surface of the magnetic film 11. A first conductive pattern C1 is formed on the upper surface of the magnetic film 12. A third conductive pattern C3 is formed on the upper surface of the magnetic film 14. A fourth conductive pattern C4 is formed on the upper surface of the magnetic film 15. The first conductive pattern C1, second conductive pattern C2, third conductive pattern C3, and fourth conductive pattern C4 all extend circumferentially about a coil axis Ax that extends in the T-axis direction. The magnetic film 11 has a rectangular shape in plan view, and the coil axis Ax passes through, for example, the intersection of its two diagonals. The coil axis Ax may instead pass through the geometric center of the magnetic film 11 in plan view.

Through-holes are formed in predetermined positions of the magnetic films 11 to 17, penetrating each magnetic film in the T-axis direction. Via conductors are embedded inside these through-holes. The conductive patterns and via conductors of the coil component 100 may be formed, for example, by: screen-printing a conductive paste containing a highly conductive metal or alloy onto a magnetic sheet, which is a precursor of each of the magnetic films 11 to 17, and heating the conductive paste printed on the magnetic sheet. The material of the conductive paste may be Ag, Pd, Cu, Al, or an alloy of these. The conductive patterns and via conductors of the coil component 100 may be formed from a material other than those named above. The conductive patterns and via conductors of the coil component 100 may also be formed by, for example, spattering, ink-jetting, or by using any other existing method.

Although the magnetic film 11 is illustrated as a single-layer sheet-like member, the magnetic film 11 may be a laminated body made up of multiple sheet-like members stacked on top of one another. Similarly, the magnetic films 12 to 18 may all be a laminated body made up of multiple sheet-like members stacked on top of one another. The thickness of the magnetic films 11 to 18 can be adjusted by adjusting the number of sheets that make up each magnetic film.

The intermediate magnetic layer 63 includes the magnetic films 12 and 13. The first magnetic layer 61 includes the magnetic films 11 and 18. The second magnetic layer 62 includes the magnetic films 14, 15, 16, and 17. Furthermore, the first conductive coil 51 includes the first conductive pattern C1 and the second conductive pattern C2. The second conductive coil 52 includes the third conductive pattern C3 and the fourth conductive pattern C4.

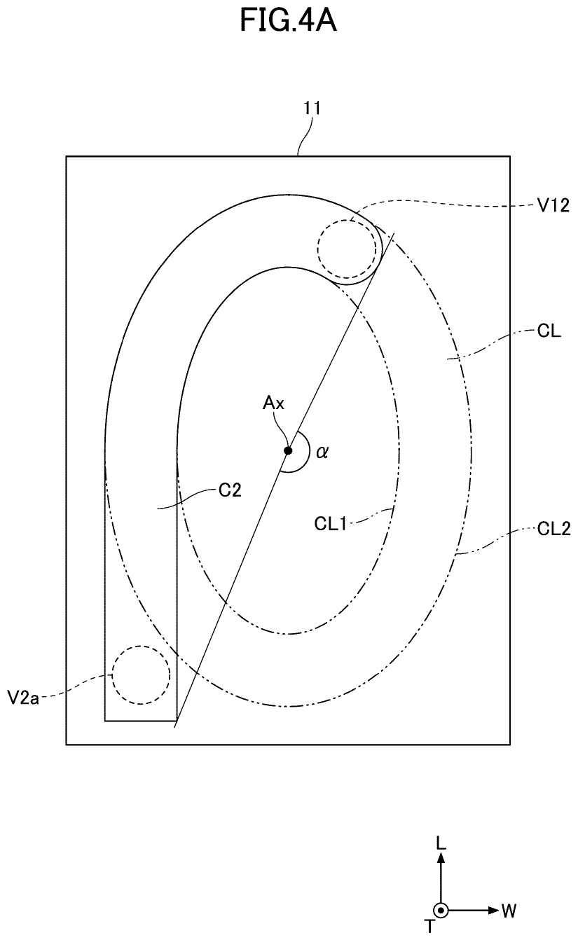

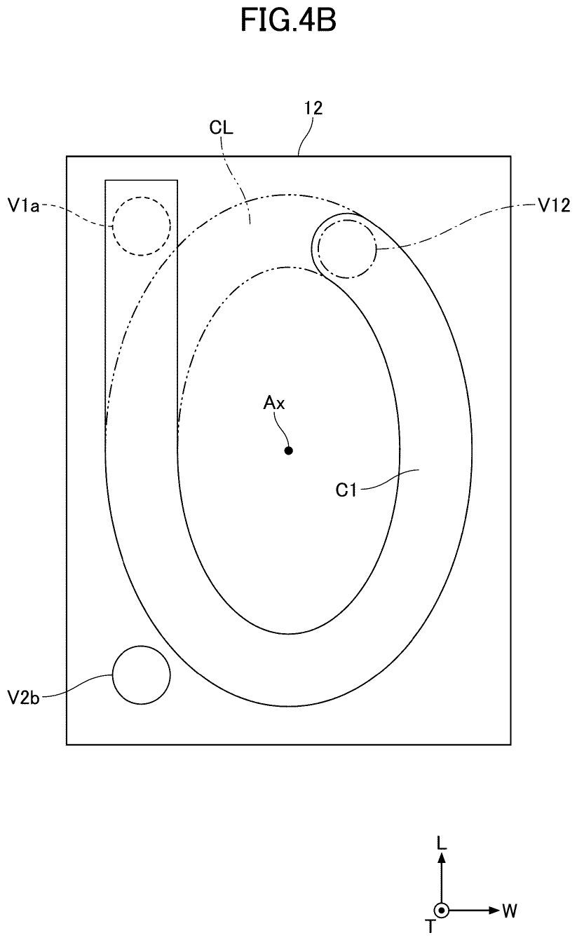

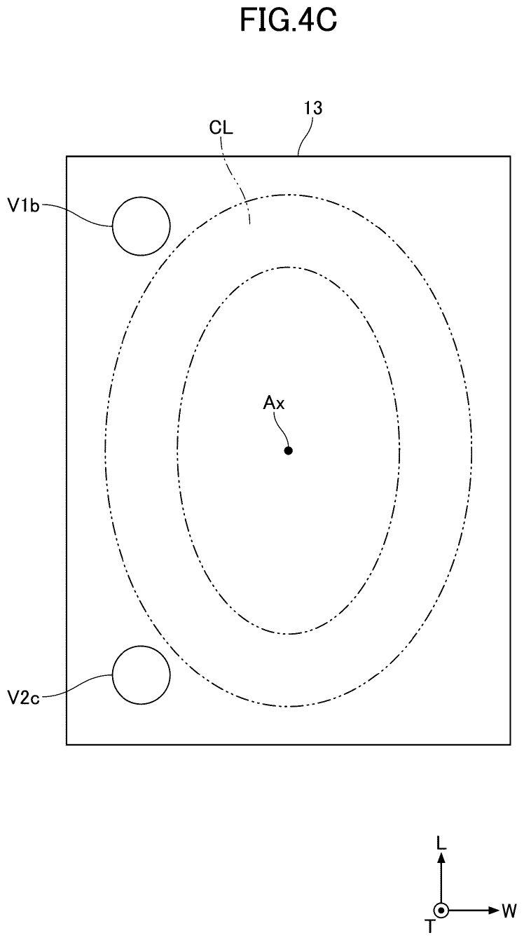

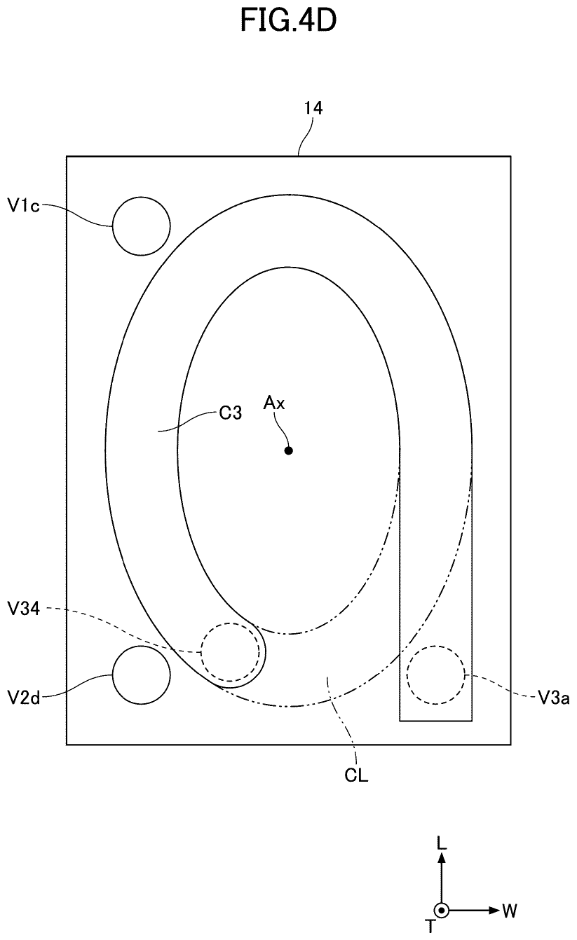

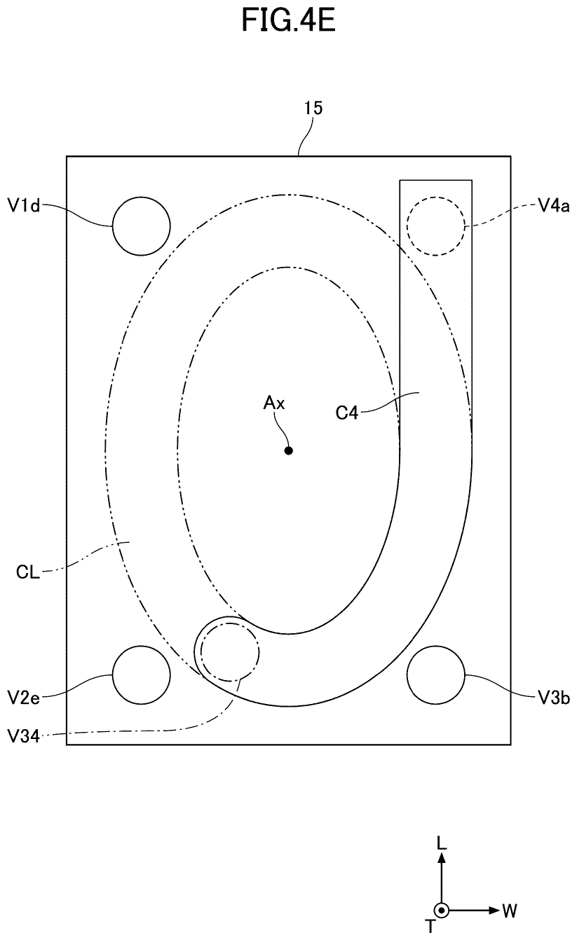

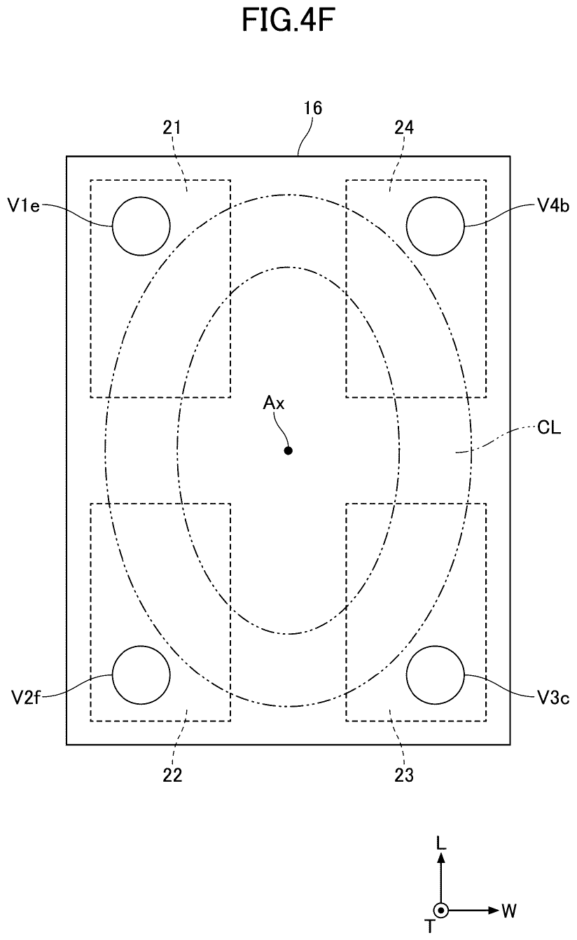

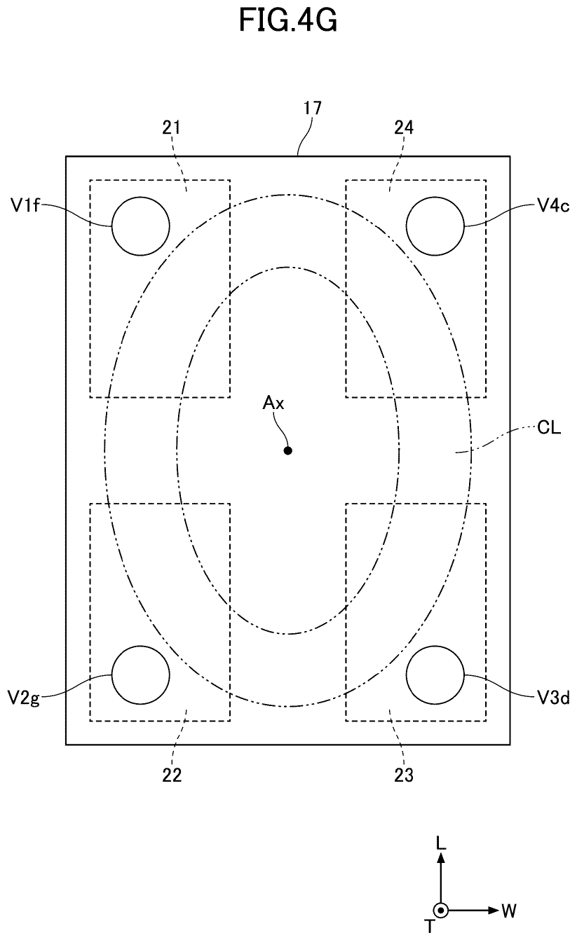

The conductive patterns and via conductors of the coil component 100 will now be described in greater detail. FIGS. 4A, 4B, 4C, 4D, 4E, 4F, and 4G are plan views showing, respectively, the magnetic films 11 to 17 and the conductive patterns provided on the magnetic films 11 to 17.

As shown in FIG. 2 and FIG. 4A, the second conductive pattern C2 is formed on the upper surface of the magnetic film 11. The second conductive pattern C2 extends circumferentially for less than one turn, about the coil axis Ax, in a plane (LW plane) that is perpendicular to the coil axis Ax. The number of turns of a conductive pattern extending circumferentially about the coil axis Ax indicates the proportion of the part where the conductive pattern is formed in the circumferential direction. For example, the number of turns of a given conductive pattern can be expressed using the central angle of the part around the coil axis Ax where the conductive pattern extends. The second conductive pattern C2 extends circumferentially, about the coil axis Ax, within a central angle range of (360°−α). The number of turns of the second conductive pattern C2 can be expressed as: (1−α/360°). For example, if α is approximately 180°, the number of turns of the second conductive pattern C2 is approximately 0.5 turns.

A through-hole that penetrates the magnetic film 11 in the T-axis direction is formed in a part of the magnetic film 11 that overlaps one end of the second conductive pattern C2. The via conductor V2a is embedded inside this through-hole. In addition, a through-hole that penetrates the magnetic film 11 in the T-axis direction is formed in a part of the magnetic film 11 that overlaps the other end of the second conductive pattern C2. A via conductor V12 is embedded inside this second through-hole.

As shown in FIG. 2 and FIG. 4B, the first conductive pattern C1 is formed on the upper surface of the magnetic film 12. The first conductive pattern C1 extends circumferentially for less than one turn, about the coil axis Ax, in a plane (LW plane) that is perpendicular to the coil axis Ax. The first conductive pattern C1 extends circumferentially for approximately 0.75 turns about the coil axis Ax. One end of the first conductive pattern C1 is connected with the via conductor V12. A through-hole that penetrates the magnetic film 12 in the T-axis direction is formed in a part of the magnetic film 12 that overlaps the other end of the first conductive pattern C1. The via conductor V1a is embedded inside this through-hole. The other end of the first conductive pattern C1 is connected with the via conductor Vla.

A through-hole that penetrates the magnetic film 12 in the T-axis direction is formed in a part of the magnetic film 12 that overlaps the via conductor V2a in plan view. The via conductor V2b is embedded inside this second through-hole. The via conductor V2b is connected with the via conductor V2a.

As shown in FIG. 2 and FIG. 4C, a through-hole that penetrates the magnetic film 13 in the T-axis direction is formed in a part of the magnetic film 13 that overlaps the via conductor V2b in plan view. The via conductor V2c is embedded inside this through-hole. The via conductor V2c is connected with the via conductor V2b. Furthermore, a through-hole that penetrates the magnetic film 13 in the T-axis direction is formed in a part of the magnetic film 13 that overlaps the via conductor V1a in plan view. The via conductor V1b is embedded inside this second through-hole. The via conductor V1b is connected with the via conductor V1a.

As shown in FIG. 2 and FIG. 4D, the third conductive pattern C3 is formed on the upper surface of the magnetic film 14. The third conductive pattern C3 has two-fold rotational symmetry with the first conductive pattern C1; the coil axis Ax is the axis of symmetry. A through-hole that penetrates the magnetic film 14 in the T-axis direction is formed in a part of the magnetic film 14 that overlaps one end of the third conductive pattern C3. The via conductor V3a is embedded inside this through-hole. Furthermore, a through-hole that penetrates the magnetic film 14 in the T-axis direction is formed in a part of the magnetic film 14 that overlaps the other end of the third conductive pattern C3. The via conductor V34 is embedded inside this second through-hole.

A through-hole that penetrates the magnetic film 14 in the T-axis direction is formed in a part of the magnetic film 14 that overlaps the via conductor V2c in plan view. The via conductor V2d is embedded inside this third through-hole. The via conductor V2d is connected with the via conductor V2c. Furthermore, a through-hole that penetrates the magnetic film 14 in the T-axis direction is formed in a part of the magnetic film 14 that overlaps the via conductor V1b in plan view. The via conductor V1c is embedded inside this fourth through-hole. The via conductor V1c is connected with the via conductor V1b.

As shown in FIG. 2 and FIG. 4E, the fourth conductive pattern C4 is formed on the upper surface of the magnetic film 15. The fourth conductive pattern C4 has two-fold rotational symmetry with the second conductive pattern C2; the coil axis Ax is the axis of symmetry. One end of the fourth conductive pattern C4 is connected to the via conductor V34. A through-hole that penetrates the magnetic film 15 in the T-axis direction is formed in a part of the magnetic film 15 that overlaps the other end of the fourth conductive pattern C4. The via conductor V4a is embedded inside this through-hole. The other end of the fourth conductive pattern C4 is connected to the via conductor V4a.

Another through-hole that penetrates the magnetic film 15 in the T-axis direction is formed in a part of the magnetic film 15 that overlaps the via conductor V2d in plan view. The via conductor V2e is embedded inside this second through-hole. The via conductor V2e is connected to the via conductor V2d. Yet another through-hole that penetrates the magnetic film 15 in the T-axis direction is formed in a part of the magnetic film 15 that overlaps the via conductor V1c in plan view. The via conductor Vid is embedded inside this third through-hole. The via conductor V1d is connected with the via conductor V1c. Yet another through-hole that penetrates the magnetic film 15 in the T-axis direction is formed in a part of the magnetic film 15 that overlaps the via conductor V3a in plan view. The via conductor V3b is embedded inside this fourth through-hole. The via conductor V3b is connected with the via conductor V3a.

As shown in FIG. 2 and FIG. 4F, a through-hole that penetrates the magnetic film 16 in the T-axis direction is formed in a part of the magnetic film 16 that overlaps the via conductor V2e in plan view. The via conductor V2f is embedded inside this through-hole. The via conductor V2f is connected to the via conductor V2e. Another through-hole that penetrates the magnetic film 16 in the T-axis direction is formed in a part of the magnetic film 16 that overlaps the via conductor Vid in plan view. The via conductor V1e is embedded inside this second through-hole. The via conductor V1e is connected with the via conductor V1d. Yet another through-hole that penetrates the magnetic film 16 in the T-axis direction is formed in a part of the magnetic film 16 that overlaps the via conductor V3b in plan view. The via conductor V3c is embedded inside this third through-hole. The via conductor V3c is connected to the via conductor V3b. Yet another through-hole that penetrates the magnetic film 16 in the T-axis direction is formed in the part of the magnetic film 16 that overlaps the via conductor V4a in plan view. The via conductor V4b is embedded inside this fourth through-hole. The via conductor V4b is connected to the via conductor V4a.

As shown in FIG. 2 and FIG. 4G, a through-hole that penetrates the magnetic film 17 in the T-axis direction is formed in a part of the magnetic film 17 that overlaps the via conductor V2f in plan view. The via conductor V2g is embedded inside this through-hole. The via conductor V2g is connected to the via conductor V2f. Another through-hole that penetrates the magnetic film 17 in the T-axis direction is formed in a part of the magnetic film 17 that overlaps the via conductor V1e in plan view. The via conductor V1f is embedded inside this second through-hole. The via conductor V1f is connected with the via conductor V1e. Yet another through-hole that penetrates the magnetic film 17 in the T-axis direction is formed in a part of the magnetic film 17 that overlaps the via conductor V3c in plan view. The via conductor V3d is embedded inside this third through-hole. The via conductor V3d is connected to the via conductor V3c. Yet another through-hole that penetrates the magnetic film 17 in the T-axis direction is formed in a part of the magnetic film 17 that overlaps the via conductor V4b in plan view. The via conductor V4c is embedded inside this fourth through-hole. The via conductor V4c is connected to the via conductor V4b.

The lower end of the via conductor V1f is connected with the first outer terminal 21. The lower end of the via conductor V2g is connected with the second outer terminal 22. The lower end of the via conductor V3d is connected with the third outer terminal 23. The lower end of the via conductor V4c is connected with the fourth outer terminal 24.

The first conductive pattern C1 and the second conductive pattern C2 are thus connected in series via the via conductor V12. The first conductive pattern C1, the via conductor V12, and the second conductive pattern C2 form a circling part 51a, which is spiral in shape and which extends for approximately 1.25 turns about the coil axis Ax in the base body 10. Furthermore, the third conductive pattern C3 and the fourth conductive pattern C4 are connected in series via the via conductor V34. The third conductive pattern C3, the via conductor V34, and the fourth conductive pattern C4 form a circling part 52a, which is spiral in shape and which extends for approximately 1.25 turns about the coil axis Ax in the base body 10.

The first lead part 51b1 has via conductors V1a to V1f that are positioned on a coaxial line extending parallel to the T-axis. The first lead part 51b1 is connected with one end of the circling part 51a (that is, one end of the first conductive pattern C1) and the first outer terminal 21. In other words, one end of the circling part 51a is connected with the first outer terminal 21 via the first lead part 51b1.

The second lead part 51b2 has via conductors V2a to V2g positioned on a coaxial line extending parallel to the T-axis. The second lead part 51b2 is connected with the other end of the circling part 51a (one end of the second conductive pattern C2) and the second outer terminal 22. In other words, the other end of the circling part 51a is connected with the second outer terminal 22 via the second lead part 51b2.

The third lead part 52b3 has via conductors V3a to V3d positioned on a coaxial line extending parallel to the T-axis. The third lead part 52b3 is connected with one end of the circling part 52a (one end of the third conductive pattern C3) and the third outer terminal 23. In other words, one end of the circling part 52a is connected with the third outer terminal 23 via the third lead part 52b3.

The fourth lead part 52b4 has via conductors V4a to V4c positioned on a coaxial line extending parallel to the T-axis. The fourth lead part 52b4 is connected with the other end of the circling part 52a (one end of the fourth conductive pattern C4) and the fourth outer terminal 24. In other words, the other end of the circling part 52a is connected with the fourth outer terminal 24 via the fourth lead part 52b4.

Looking at the coil component 100 in plan view (that is, viewed from the T-axis direction), a part of the circling part 51a extends for one turn or more along an elliptical closed loop trajectory CL. The closed loop trajectory CL is the part between: an inner circumferential surface CL1, which is elliptical in shape; and an outer circumferential surface CL2, which is elliptical in shape and which has a larger diameter than the inner circumferential surface CL1. The closed loop trajectory CL need not be elliptical in shape. In plan view, the closed loop trajectory CL may be oval, circular, rectangular, or polygonal in shape, or may be shaped in a variety of different ways.

In the coil component 100 according to the first embodiment, as shown in FIG. 3, the first conductive pattern C1 is thinner than the second conductive pattern C2, and the third conductive pattern C3 is thinner than the fourth conductive pattern C4. The thickness T1 of the first conductive pattern C1 and the thickness T3 of the third conductive pattern C3 are equal. The thickness T2 of the second conductive pattern C2 and the thickness T4 of the fourth conductive pattern C4 are equal.

Because the first conductive pattern C1 is thinner than the second conductive pattern C2 and the third conductive pattern C3 is thinner than the fourth conductive pattern C4, the coupling factor between the first conductive coil 51 and the second conductive coil 52 can be improved. Looking at this the other way around, the second conductive pattern C2 is thicker than the first conductive pattern C1, and the fourth conductive pattern C4 is thicker than the third conductive pattern C3. This allows the electrical resistance of the first conductive coil 51 and the second conductive coil 52 to be kept low. In other words, the coil component 100 allows for an improved coupling factor with low resistance.

The thinner the first conductive pattern C1 and the third conductive pattern C3, the easier it is to improve the coupling factor between the first conductive coil 51 and the second conductive coil 52. Consequently, the thickness T1 of the first conductive pattern C1 is preferably 80% or less, more preferably 60% or less, and even more preferably 50% or less, of the thickness T2 of the second conductive pattern C2. Furthermore, the thickness T3 of the third conductive pattern C3 is preferably 80% or less, more preferably 60% or less, and even more preferably 50% or less, of the thickness T4 of the fourth conductive pattern C4.

On the other hand, if the first conductive pattern C1 is too thin, the electrical resistance of the first conductive coil 51 may become too high. Consequently, the thickness T1 of the first conductive pattern C1 is preferably 10% or more, and more preferably 15% or more, of the thickness T2 of the second conductive pattern C2. Furthermore, if the third conductive pattern C3 is too thin, the electrical resistance of the second conductive coil 52 may become too high. Consequently, the thickness T3 of the third conductive pattern C3 is preferably 10% or more, and more preferably 15% or more, of the thickness T4 of the fourth conductive pattern C4.

Next, an example method of manufacturing the coil component 100 will be described. The coil component 100 can be manufactured by, for example, a layering process. An example of a method for manufacturing the coil component 100 by sheet lamination will be described below.

First, magnetic sheets that serve as precursors for the magnetic films (magnetic films 11 to 18) that make up the base body 10 together are prepared. The magnetic sheets can be prepared, for example, by: preparing a slurry by mixing soft magnetic metal particles and resin together; applying this slurry to the surface of a plastic base film by doctor blading or any other common method and drying the surface; and cutting the dried slurry to desired size.

Next, in each one of the magnetic sheets that serve as precursors of the magnetic films 11 to 17, through-holes that penetrate the magnetic sheet in the T-axis direction are formed in predetermined locations. Next, a conductive paste is printed on the upper surface of each magnetic sheet, which will be the magnetic films 11 to 17, by screen-printing, thereby forming unfired conductive patterns on the magnetic sheets, and thereupon placing a conductive paste inside each through-hole formed in the magnetic sheets. The conductive patterns can be formed using a variety of existing methods besides screen printing.

The unfired conductive pattern formed on the magnetic sheet that serves as the precursor of the magnetic film 11 becomes the second conductive pattern C2 after it is heated. The unfired conductive pastes embedded inside the two through-holes formed in this magnetic sheet become the via conductors V2a and V12 after they are heated. The unfired conductive pattern formed on the magnetic sheet that serves as the precursor of the magnetic film 12 becomes the first conductive pattern C1 after it is heated. The unfired conductive pastes embedded inside the two through-holes formed in this magnetic sheet become the via conductors V2b and V1a after they are heated. The unfired conductive pastes embedded inside the two through-through-holes formed in this magnetic sheet that serves as the precursor of the magnetic film 13 become the via conductors V2c and V1b after they are heated.

The unfired conductive pattern formed on the magnetic sheet that serves as the precursor of the magnetic film 14 becomes the third conductive pattern C3 after it is heated. The unfired conductive pastes embedded inside the four through-holes formed in this magnetic sheet become the via conductors V2d, V1c, V3a, and V34 after they are heated. The unfired conductive pattern formed on the magnetic sheet that serves as the precursor of the magnetic film 15 becomes the fourth conductive pattern C4 after it is heated. The unfired conductive pastes embedded inside the four through-holes formed in this magnetic sheet become the via conductors V2e, V1d, V3b, and V4a after they are heated. The unfired conductive pastes embedded inside the four through-through-holes formed in this magnetic sheet that serves as the precursor of the magnetic film 16 become the via conductors V2f, V1e, V3c, and V4b after they are heated. The unfired conductive pastes embedded inside the four through-through-holes formed in this magnetic sheet that serves as the precursor of the magnetic film 17 become the via conductors V2g, V1f, V3d, and V4c after they are heated.

The magnetic sheet that serves as the precursor of the magnetic film 11 may be a single magnetic sheet or a multi-layer sheet made up of multiple magnetic sheets stacked on top of one another. Similarly, all the magnetic sheets that serve as the precursors of the magnetic films 12 to 18 may be a single magnetic sheet or a multi-layer sheet made up of multiple magnetic sheets stacked on top of one another. The thickness of the magnetic films 11 to 18 can be adjusted by adjusting the number of magnetic sheets that make up each magnetic film.

Next, the magnetic sheets that serve as precursors of the magnetic films 11 to 17 are stacked on top of one another, thus resulting in a laminated body. The laminated body may also be obtained by thermo-compressing the layered magnetic sheets together using a press machine. The laminated body is then cut to a piece of a predetermined size by using a cutting machine such as a dicing machine or laser processing machine, thus forming a chip laminated body. If necessary, the edges of the chip laminated body may be rounded, for example by barrel polishing.

Next, this chip laminated body is degreased and then subjected to heat treatment, to obtain the base body 10. By this heat treatment, an oxide layer is formed on the surface of each soft magnetic metal particle contained in the magnetic sheets, so that soft magnetic metal particles that neighbor each other are coupled via the oxide layer. The heat treatment of the chip laminated body is performed such that, for example, the heating temperature is 600° C. to 800° C. and the heating lasts 20 minutes to 120 minutes.

Next, a conductive paste is applied to the second main surface 10b, which serves as the mounting surface of the base body 10, and then fired, thereby forming the first outer terminal 21, second outer terminal 22, third outer terminal 23, and fourth outer terminal 24. The first outer terminal 21, second outer terminal 22, third outer terminal 23, and fourth outer terminal 24 may include a plating layer. This plating layer may consist of two or more layers. The two plating layers may include: a Ni plating layer; and an Sn plating layer located outward of the Ni plating layer. In this manner, the coil component 100 is obtained.

The coil component 100 may be manufactured by compression molding, thin film processing, slurry building, or any other existing method.

Some of the steps included in the above manufacturing method may be omitted as appropriate. In the above-described method of manufacturing the coil component 100, steps not explicitly described in this specification may be performed on an as-needed basis. Some of the steps included in the above-described method of manufacturing the coil component 100 may be ordered differently if necessary, as long as such alteration does not result in deviation from the spirit of the present disclosure. Some of the steps included in the above method of manufacturing the coil component 100 may be performed simultaneously or in parallel, if possible.

### Second Embodiment

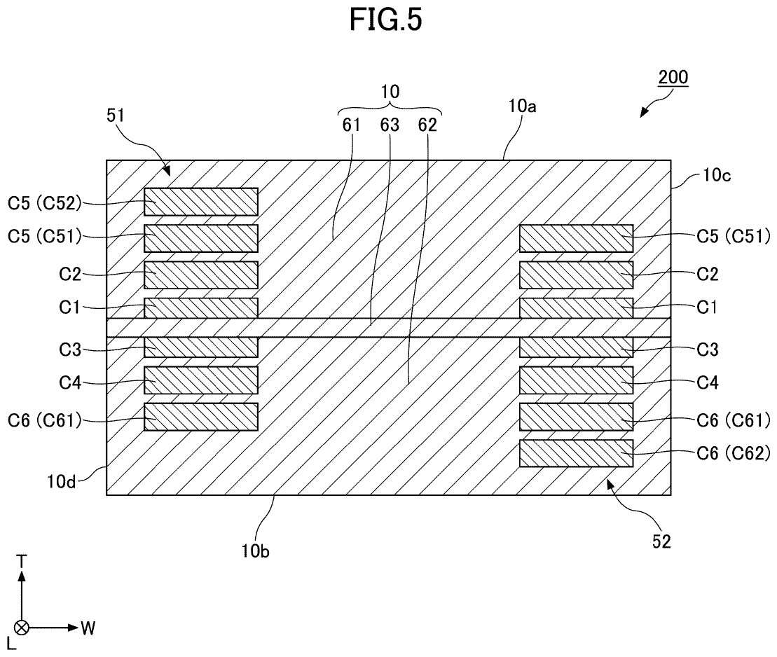

A second embodiment will be described now. The second embodiment is different from the first embodiment mainly in the number of conductive patterns included in the coil conductor. FIG. 5 is a cross-sectional view showing a magnetically-coupling coil component according to the second embodiment. For ease of explanation, the outer terminals are not illustrated in FIG. 5.

Referring to FIG. 5, in a magnetically-coupling coil component 200 according to the second embodiment, the first conductive coil 51 includes two fifth conductive patterns C5, in addition to the first conductive pattern C1 and the second conductive pattern C2, and the second conductive coil 52 includes two sixth conductive patterns C6, in addition to the third conductive pattern C3 and the fourth conductive pattern C4.

The first one of the two fifth conductive patterns C5 (C51) is connected in series to the second conductive pattern C2 by a via conductor (not shown). The second fifth conductive patterns C5 (C52) is connected in series to the first fifth conductive pattern C51 by a via conductor (not shown). The fifth conductive patterns C51 and C52 are layered above the second conductive pattern C2. The circling part 51a includes the fifth conductive patterns C51 and C52. The second lead part 51b2 is connected with the end of the fifth conductive pattern C52 located nearer to the first main surface 10a, but not connected with an end of the second conductive pattern C2. The thickness of the fifth conductive patterns C51 and C52 is equal to the thickness of the second conductive pattern C2.

The first one of the two sixth conductive pattern C6 (C61) and the fourth conductive pattern C4 are connected in series to by a via conductor (not shown). The second sixth conductive pattern C6 (C62) is connected in series to the first sixth conductive pattern C61 by a via conductor (not shown). The sixth conductive patterns C61 and C62 are layered below the fourth conductive pattern C4. The circling part 52a includes the sixth conductive patterns C61 and C62. The fourth lead part 52b4 is connected with the end of the sixth conductive pattern C62 located nearer to the second main surface 10b, but not connected with an end of the fourth conductive pattern C4. The thickness of the sixth conductive patterns C61 and C62 is equal to the thickness of the fourth conductive pattern C4.

The rest of the structure/configurations of the second embodiment are the same as those of the first embodiment. The second embodiment can also achieve the same advantages as those of the first embodiment.

The number of the fifth conductive patterns C5 is not limited to two, and may be one, three, or more. Similarly, the number of the sixth conductive patterns C6 is not limited to two, and may be one, three, or more. Furthermore, the fifth conductive patterns C51 and C52 may be thicker than the second conductive pattern C2, and the sixth conductive patterns C61 and C62 may be thicker than the fourth conductive pattern C4.

In the present disclosure, the number of conductive patterns included in the first conductive coil 51 and the number of conductive patterns included in the second conductive coil 52 are not limited. For example, the number of conductive patterns included in the first conductive coil 51, including the first conductive pattern C1 and the second conductive pattern C2, may be four or less. Furthermore, the number of conductive patterns included in the second conductive coil 52, including the third conductive pattern C3 and the fourth conductive pattern C4, may be four or less.

### Third Embodiment

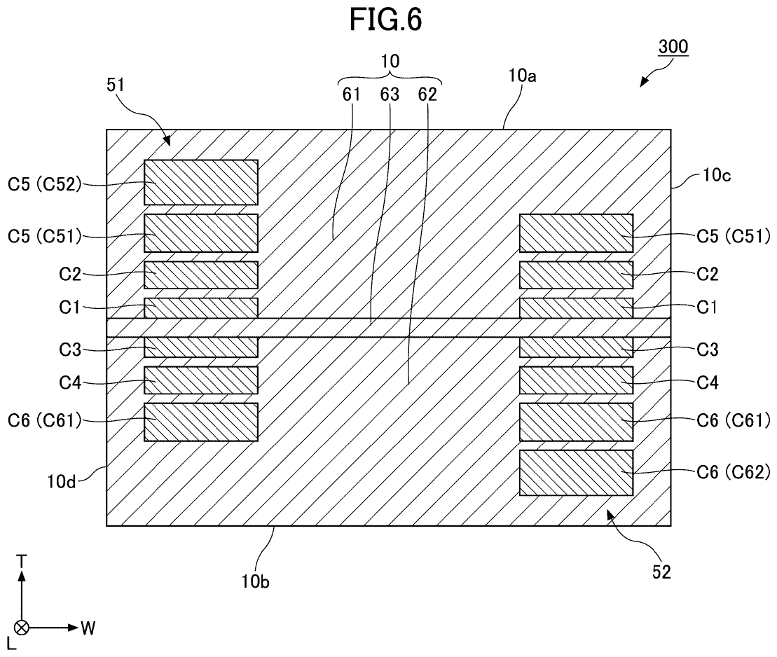

A third embodiment will be described now. The third embodiment is different from the second embodiment primarily in the thickness of the fifth conductive patterns and the sixth conductive patterns. FIG. 6 is a cross-sectional view showing a magnetically-coupling coil component of the third embodiment. For ease of explanation, the outer terminals are not illustrated in FIG. 6.

Referring to FIG. 6, in a magnetically-coupling coil component 300 according to the third embodiment, the fifth conductive patterns C51 are thicker than the second conductive patterns C2, and the fifth conductive pattern C52 is thicker than the fifth conductive patterns C51. In other words, among the fifth conductive patterns C51 and C52, one that is positioned further from the second conductive patterns C2 is thicker. Similarly, the sixth conductive patterns C61 are thicker than the fourth conductive patterns C4, and the sixth conductive pattern C62 is thicker than the sixth conductive patterns C61. In other words, among the sixth conductive patterns C61 and C62, one that is positioned further from the fourth conductive patterns C4 is thicker.

The rest of the structure/configurations of the third embodiment are the same as those of the second embodiment. The third embodiment can also achieve the same advantages as those of the second embodiment. In addition, the coupling factor can be improved more.

### (Simulations)

Next, simulations conducted by the present inventors will be described.

### [First Simulation]

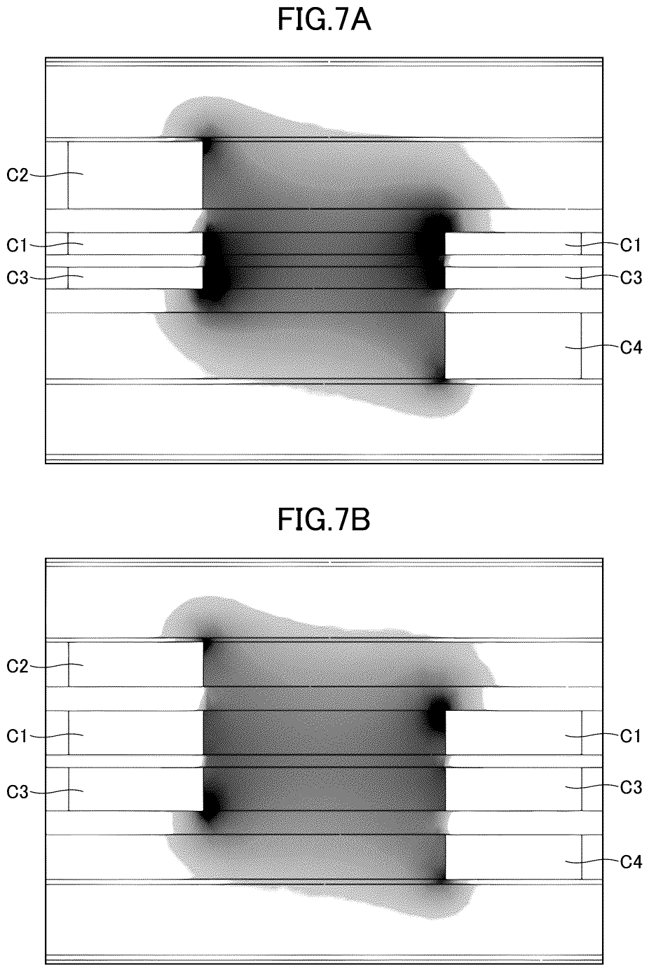

In the first simulation, the distribution of magnetic flux density was calculated under two conditions: 1A and 1B. The condition 1A corresponds to the first embodiment. That is, the thickness T1 and the thickness T3 were thinner than the thickness T2 and the thickness T4. The thickness T1 and the thickness T3 were equal, and the thickness T2 and the thickness T4 were equal. Under the condition 1B, the thickness T1, T2, T3, and T4 were all equal. Furthermore, the total thickness of conductive patterns included in the circling parts 51a and 52a was equal between the condition 1A and the condition 1B. FIG. 7A shows the distribution of magnetic flux density obtained under the condition 1A. FIG. 7B shows the distribution of magnetic flux density obtained under the condition 1B.

As can be seen by comparing FIG. 7A and FIG. 7B, under the condition 1A, the magnetic flux density near the center magnetic layer was higher than under the condition 1B. Furthermore, the coupling factor calculated was 0.490 under the condition 1A and 0.445 under the condition 1B. That is, the coupling factor under the condition 1A was higher than that under the condition 1B. This indicates that the first embodiment can improve the coupling factor.

### [Second Simulation]

A second simulation was conducted to calculate the coupling factor based on five conditions: 2A, 2B, 2C, 2D, and 2E. The conditions 2A, 2B, 2C, and 2D correspond to the first embodiment. That is, the thickness T1 and the thickness T3 were thinner than the thickness T2 and the thickness T4. The thickness T1 and the thickness T3 were equal, and the thickness T2 and the thickness T4 were equal. Under the condition 2E, the thicknesses T1, T2, T3, and T4 were all equal. The total thickness of conductive patterns included in the circling parts 51a and 52a was made equal throughout the conditions 2A, 2B, 2C, 2D, and 2E. The proportion of the thickness T1 of the first conductive pattern C1 and the thickness T3 of the third conductive pattern C3 to the thickness T2 of the second conductive pattern C2 and the thickness T4 of the fourth conductive pattern C4 was made different among the conditions 2A, 2B, 2C, 2D, and 2E. To be more specific, the proportion of thickness was 20% under the condition 2A, 50% under the condition 2D, and 100% under the condition 2E.

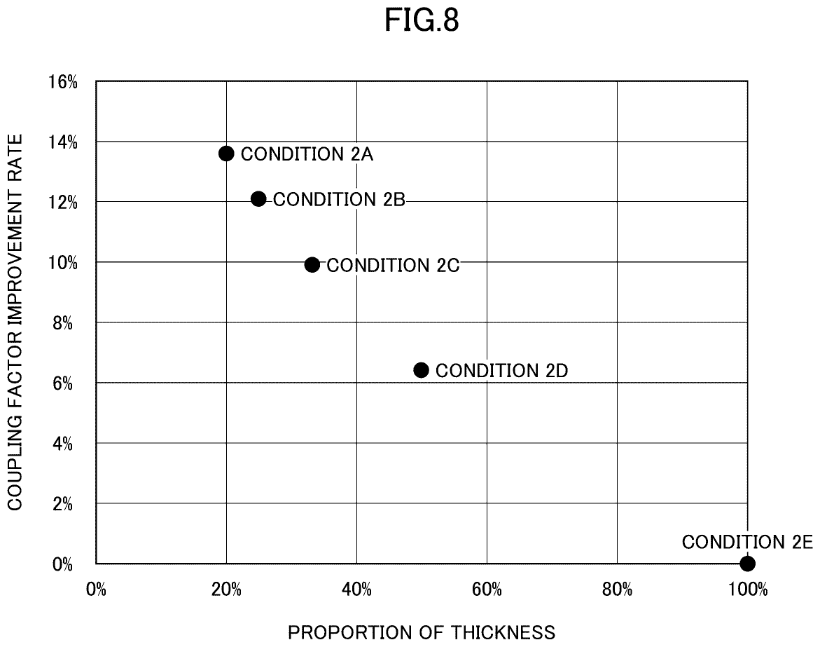

As for the coupling factor, the proportion of the difference between the coupling factor k1 calculated under each condition (2A, 2B, 2C, 2D, and 2E), and the coupling factor k0 calculated under the condition 2E (i.e., ((k1−k0)/k0)×100) was calculated as a coupling factor improvement rate. FIG. 8 shows the result of the second simulation.

As shown in FIG. 8, the lower the proportion of thickness, the higher the coupling factor and the higher the rate of the coupling factor's improvement. This indicates that the first embodiment can improve the coupling factor.

### [Third Simulation]

In the third simulation, the coupling factor was calculated under seven conditions: 3A, 3B, 3C, 3D, 3E, 3F, and 3G. Of the seven, the six conditions 3A, 3B, 3C, 3D, 3E, and 3F correspond to the second embodiment. That is, the thickness T1 and the thickness T3 were thinner than the thickness T2 and the thickness T4. The thickness T1 and the thickness T3 were equal, and the thickness T2 and the thickness T4 were equal. Under the last condition 3G, the thickness T1, T2, T3, and T4 were all equal. The thickness of the fifth conductive pattern C5 and the thickness of the sixth conductive pattern C6 were equal to the thickness T2 of the second conductive pattern C2 and the thickness T4 of the fourth conductive pattern C4. Furthermore, the total thickness of conductive patterns included in the circling parts 51a and 52a was made equal throughout the conditions 3A, 3B, 3C, 3D, 3E, 3F, and 3G. On the other hand, the proportion of thickness was made different among the conditions 3A, 3B, 3C, 3D, 3E, 3F, and 3G.

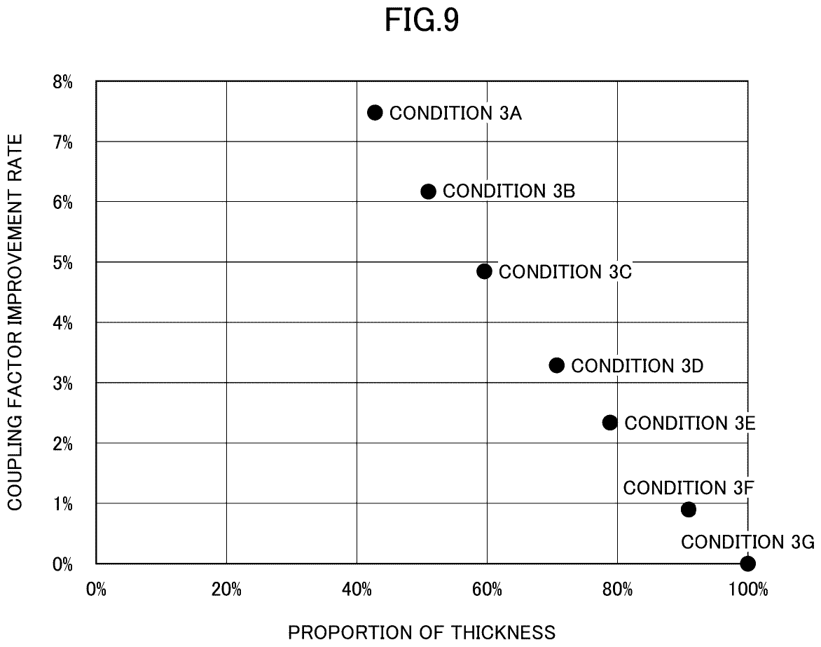

As for the coupling factor, the proportion of the difference between the coupling factor k1 calculated under each condition (3A, 3B, 3C, 3D, 3E, 3F, and 3G), and the coupling factor k0 calculated under the condition 3G was calculated (i.e., ((k1−k0)/k0)×100) as a coupling factor improvement rate. FIG. 9 shows the result of the third simulation.

As shown in FIG. 9, similar to the second simulation, the lower the proportion of thickness, the higher the coupling factor and the higher the rate of the coupling factor's improvement. This indicates that the second embodiment can improve the coupling factor.

### [Fourth Simulation]

In the fourth simulation, the coupling factor was calculated under four conditions: 4A, 4B, 4C, and 4D. The conditions 4A, 4B, 4C, and 4D correspond to the third embodiment. That is, the thickness T1 and the thickness T3 were thinner than the thickness T2 and the thickness T4. The thickness T1 and the thickness T3 were equal, and the thickness T2 and the thickness T4 were equal. The fifth conductive pattern C5 was thicker in proportion to how far it was from the second conductive pattern C2. Similarly, the sixth conductive pattern C6 was thicker in proportion to how far it was from the fourth conductive pattern C4. Under the condition 4D, the thickness T1, T2, T3, and T4 were all equal, and the thickness of the fifth conductive pattern C5 and the thickness of the sixth conductive pattern C6 were also equal to the thickness T1, T2, T3, and T4. The total thickness of conductive patterns included in the circling parts 51a and 52a was made equal throughout the conditions 4A, 4B, 4C, and 4D. On the other hand, the thickness of each conductive pattern was made different among the conditions 4A, 4B, 4C, and 4D. Table 1 shows the thickness of each conductive pattern under the conditions 4A, 4B, 4C, and 4D. According to Table 1, under the condition 4A, in both the first conductive coil 51 and the second conductive coil 52, the thickness of conductive patterns increases by approximately 30% per unit distance each conductive pattern gets further from the intermediate magnetic layer 63. Likewise, under the condition 4B, in both the first conductive coil 51 and the second conductive coil 52, the thickness of conductive patterns increases by approximately 20% per unit distance each conductive pattern gets further from the intermediate magnetic layer 63. According to the condition 4C, in both the first conductive coil 51 and the second conductive coil 52, the thickness of the conductive pattern increases by approximately 10% per unit distance each conductive pattern gets further from the intermediate magnetic layer 63.

TABLE 1

| | CONDITION | | | |
|---|---|---|---|---|
| CONDUCTIVE | | | | 4D |
| PATTERN | 4A | 4B | 4C | (3G) |
| C52 | 127.8 | 115.9 | 103.2 | 90 |
| C51 | 98.3 | 96.6 | 93.9 | 90 |
| C2 | 75.6 | 80.5 | 85.3 | 90 |
| C1 | 58.2 | 67.1 | 77.6 | 90 |
| C3 | 58.2 | 67.1 | 77.6 | 90 |
| C4 | 75.6 | 80.5 | 85.3 | 90 |
| C61 | 98.3 | 96.6 | 93.9 | 90 |
| C62 | 127.8 | 115.9 | 103.2 | 90 |

(UNIT OF MEASURE: μm)

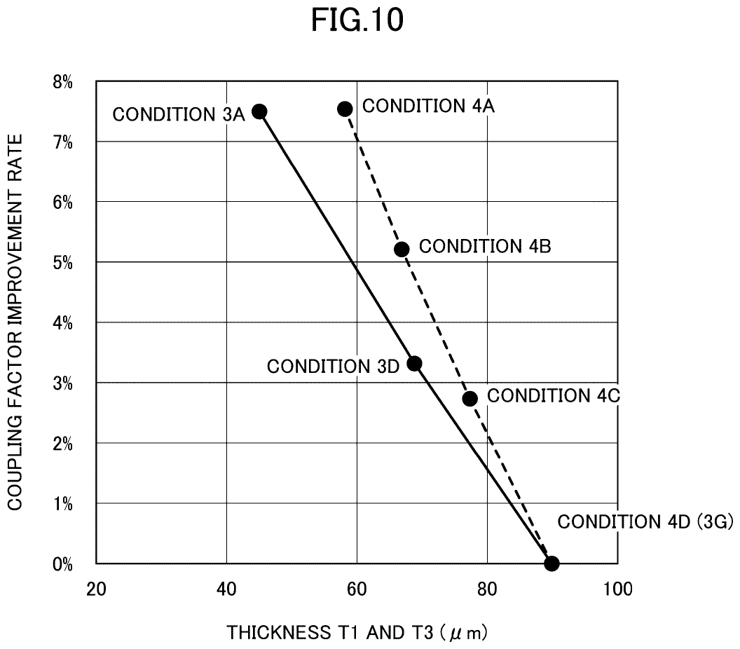

As for the coupling factor, the proportion of the difference between the coupling factor k1 calculated under each condition (4A, 4B, 4C, and 4D), and the coupling factor k0 calculated under the condition 4D was calculated (i.e., ((k1−k0)/k0)×100) as a coupling factor improvement rate. FIG. 10 shows the result of the fourth simulation. For reference, FIG. 10 shows part of the result obtained by the third simulation.

According to Table 1 and FIG. 10, the greater the difference between neighboring conductive patterns in thickness, the higher the coupling factor and the higher the rate of improvement of the coupling factor. This indicates that the third embodiment can improve the coupling factor. Furthermore, comparing the rate of coupling factor improvement for the thickness T1 and the thickness T3, which are equal, between the third simulation and the fourth simulation, the rate of the coupling factor's improvement was higher in the fourth simulation than in the third simulation. This indicates that the third embodiment can improve the coupling factor more easily, that is, with lower resistance, than the second embodiment.

Prefixes such as “first,” “second,” and “third” in this specification are simply used to identify different components and do not necessarily limit the number, order, or specifics of components. Furthermore, reference numbers that designate components are different from context to context, and a number used in one context may not necessarily designate the same component in another context. Furthermore, this does not prevent a component identified by one reference number from implementing the function of a component identified by another reference number.

Examples of the present disclosure include, for example:

<1>

A magnetically-coupling coil component including: a magnetic base body including: an intermediate magnetic layer; a first magnetic layer positioned above the intermediate magnetic layer; and a second magnetic layer positioned below the intermediate magnetic layer; a first conductive coil positioned inside the first magnetic layer; and a second conductive coil positioned inside the second magnetic layer. The first conductive coil includes: a first conductive pattern; and a second conductive pattern electrically connected in series to the first conductive pattern and positioned farther from the intermediate magnetic layer than is the first conductive pattern. The second conductive coil includes: a third conductive pattern; and a fourth conductive pattern electrically connected in series to the third conductive pattern and positioned farther from the intermediate magnetic layer than is the third conductive pattern. The first conductive pattern is thinner than the second conductive pattern. The third conductive pattern is thinner than the fourth conductive pattern.

<2>

The magnetic coupling coil component according to <1>, in which: the thickness of the first conductive pattern may be 10% to 80% of the thickness of the second conductive pattern; and the thickness of the third conductive pattern may be 10% to 80% of the thickness of the fourth conductive pattern.

<3>

The magnetic coupling coil component according to <1>, in which: the thickness of the first conductive pattern may be 15% to 60% of the thickness of the second conductive pattern; and the thickness of the third conductive pattern may be 15% to 60% of the thickness of the fourth conductive pattern.

<4>

The magnetic coupling coil component according to any one of <1> to <3>, in which: the thickness of the first conductive pattern and the thickness of the third conductive pattern may be equal; and the thickness of the second conductive pattern and the thickness of the fourth conductive pattern may be equal.

<5>

The magnetic coupling coil component according to any one of <1> to <4>, in which: the first conductive coil may include one or more fifth conductive patterns that are electrically connected in series to the second conductive that are from the pattern and positioned farther intermediate magnetic layer than is the second conductive pattern; the second conductive coil may include one or more sixth conductive patterns that are electrically connected in series to the fourth conductive pattern and that are positioned farther from the intermediate magnetic layer than is the fourth conductive pattern; the thicknesses of the one or more fifth conductive patterns may be each greater than to the thickness of the second conductive pattern; and the thicknesses of the one or more sixth conductive patterns may be each greater than or equal to the thickness of the fourth conductive pattern.

<6>

The magnetic coupling coil component according to <5>, in which: the one or more fifth conductive patterns may be each thicker than the second conductive pattern; and the one or more sixth conductive patterns may be each thicker than the fourth conductive pattern.

<7>

The magnetic coupling coil component according to <5>, in which: the thicknesses of the one or more fifth conductive patterns may increase as a function of distance from the second conductive pattern; and the thicknesses of the one or more sixth conductive patterns may increase as a function of distance from the fourth conductive pattern.

<8>

The magnetic coupling coil component according to any one of <1> to <7>, in which: the first conductive coil may include four or fewer conductive patterns that are electrically connected in series with each other, the four or fewer conductive patterns of the first conductive coil including the first conductive pattern and the second conductive pattern; and the second conductive coil may include four or fewer conductive patterns that are electrically connected in series with each other, the four or fewer conductive patterns of the second conductive coil including the third conductive pattern and the fourth conductive pattern.

What is claimed is:

1. A magnetically-coupling coil component comprising:
a magnetic base body including:
an intermediate magnetic layer;
a first magnetic layer positioned above the intermediate magnetic layer; and
a second magnetic layer positioned below the intermediate magnetic layer;
a first conductive coil positioned inside the first magnetic layer; and
a second conductive coil positioned inside the second magnetic layer,
wherein the first conductive coil includes:
a first conductive pattern; and
a second conductive pattern electrically connected in series to the first conductive pattern and positioned farther from the intermediate magnetic layer than is the first conductive pattern,
wherein the second conductive coil includes:
a third conductive pattern; and
a fourth conductive pattern electrically connected in series to the third conductive pattern and positioned farther from the intermediate magnetic layer than is the third conductive pattern,
wherein the first conductive pattern is thinner than the second conductive pattern, and
wherein the third conductive pattern is thinner than the fourth conductive pattern.

2. The magnetically-coupling coil component according to claim 1,
wherein a thickness of the first conductive pattern is 10% to 80% of a thickness of the second conductive pattern, and
wherein a thickness of the third conductive pattern is 10% to 80% of a thickness of the fourth conductive pattern.

3. The magnetically-coupling coil component according to claim 1,
wherein a thickness of the first conductive pattern is 15% to 60% of a thickness of the second conductive pattern, and
wherein a thickness of the third conductive pattern is 15% to 60% of a thickness of the fourth conductive pattern.

4. The magnetically-coupling coil component according to claim 1,
wherein a thickness of the first conductive pattern and a thickness of the third conductive pattern are equal, and
wherein a thickness of the second conductive pattern and a thickness of the fourth conductive pattern are equal.

5. The magnetically-coupling coil component according to claim 1,
wherein the first conductive coil includes one or more fifth conductive patterns that are electrically connected in series to the second conductive pattern and that are positioned farther from the intermediate magnetic layer than is the second conductive pattern,
wherein the second conductive coil includes one or more sixth conductive patterns that are electrically connected in series to the fourth conductive pattern and that are positioned farther from the intermediate magnetic layer than is the fourth conductive pattern,
wherein thicknesses of the one or more fifth conductive patterns are each greater than or equal to a thickness of the second conductive pattern, and
wherein thicknesses of the one or more sixth conductive patterns are each greater than or equal to a thickness of the fourth conductive pattern.

6. The magnetically-coupling coil component according to claim 5,
wherein the one or more fifth conductive patterns are each thicker than the second conductive pattern, and
wherein the one or more sixth conductive patterns are each thicker than the fourth conductive pattern.

7. The magnetically-coupling coil component according to claim 5,
wherein thicknesses of the one or more fifth conductive patterns as a function of distance from the second conductive pattern, and
wherein thicknesses of the one or more sixth conductive patterns as a function of distance from the fourth conductive pattern.

8. The magnetically-coupling coil component according to claim 1,
wherein the first conductive coil includes four or fewer conductive patterns that are electrically connected in series with each other, the four or fewer conductive patterns of the first conductive coil including the first conductive pattern and the second conductive pattern, and
wherein the second conductive coil includes four or fewer conductive patterns that are electrically connected in series with each other, the four or fewer conductive patterns of the second conductive coil including the third conductive pattern and the fourth conductive pattern.
